(19) United States
(12) Patent Application Publication
(10) Pub. No.: US 2012/0092878 A1
(43) Pub. Date: Apr. 19, 2012

(54) HOUSING STRUCTURE OF A LAMP

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/272,231

(22) Filed: Oct. 13, 2011

(30) Foreign Application Priority Data
Oct. 14, 2010 (TW) 099135008

(51) Int. Cl. F21V 15/00

(52) U.S. Cl. 362/362

(57) ABSTRACT

The present invention relates to a housing structure of a lamp, which includes a square base board and a plurality of sidewalls. The sidewalls extend upwardly from a periphery of the base board, and connect with each other. The sidewalls each have at least a tongue at one side thereof, and a concave at an opposite side thereof. The adjacent sidewalls are connected together by the tongue of one sidewall engaging in the concave recessed inwardly from an outer surface the other sidewall. A spot welding is applied to each of the tongues.

### BACKGROUND

1. Technical Field

The invention relates to a housing structure of a lamp, and, in particular, to a housing structure of a square LED (light emitting diode) ceiling lamp.

2. Description of Related Art

A lamp generally comprises a light source, an electronic device and a housing. The light source and the electronic device are disposed on a base board of the housing, and the light source is driven by the electronic device to illuminate.

The housing has a plurality of sidewalls arranged around the base board. Two adjacent sidewalls are assembled together by welding at joining edges of the adjacent sidewalls. Due to the joining edges are located at a corner of the housing, some processes, for example, grinding and polishing are needed after the welding to level the surface of the welded joints. The welding, grinding and polishing are laborious, time-consuming and accordingly costly.

As described above, it is important to provide a housing structure of a lamp which can solve the above-mentioned problems.

### BRIEF DESCRIPTION OF THE DRAWINGS

The invention will become more fully understood from the detailed description given herein below illustrations only, and thus is not limitative of the present invention, and wherein:

FIG. 1 is a plan view of a housing structure of a lamp according to an embodiment of the invention, wherein the housing structure is in an unfolded state.

FIG. 2 is a cross-sectional view of the housing structure of the lamp of FIG. 1, wherein the housing structure is in a folded state.

FIG. 3 is an isomeric view the housing structure of the lamp of FIG. 2.

### DETAILED DESCRIPTION

A housing structure of a lamp according to preferred embodiments of the invention will be described herein below with reference to the accompanying drawings, wherein the same reference numbers refer to the same elements.

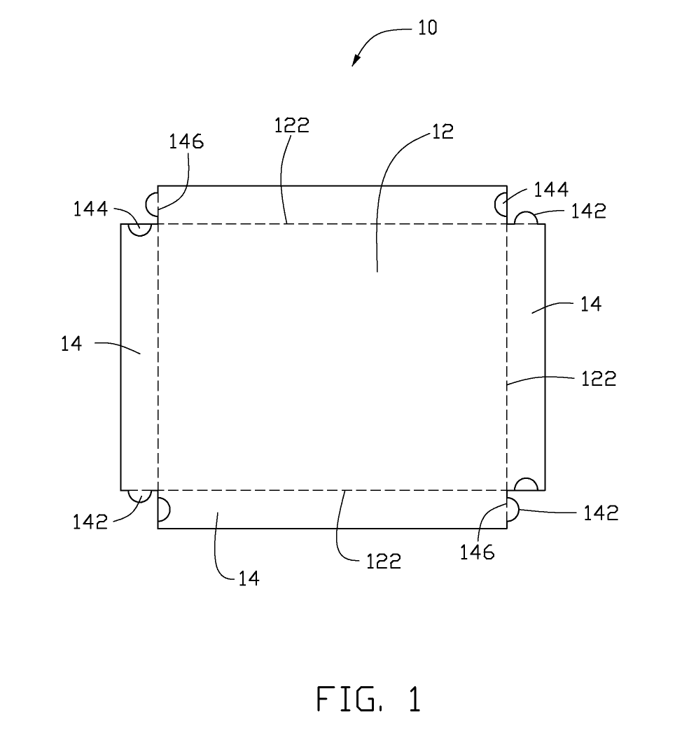

Referring to FIG. 1, a housing structure 10 of a lamp according to an embodiment of the invention includes a base board 12 and a plurality of sidewalls 14. In the embodiment, the base board 12 is a square plate. The lamp is a square LED ceiling lamp.

There are four sidewalls 14 around the base board 12. The sidewalls 14 are extended outward around from the base board 12. A folding line 122 is existed between each of the sidewalls 14 and the base board 12. The sidewall 14 can be bended along the folding line 122 so that an angle of ninety degrees (90°) is formed between the sidewall 14 and the base board 12.

Each sidewall 14 has at least a tongue 142 and at least a concave 144. The tongue 142 and the concave 144 are located at two opposite sides of the sidewall 14, respectively, in which the tongue 142 extends outwardly from one of the sides and the concave 144 is inward of the other side and recessed downwardly as viewed from FIG. 1. The two opposite sides of the sidewall 14 are aligned with the folding lines 122 of two adjacent sidewalls 14. The shapes of the tongue 142 and the concave 144 may be rectangular, semicircular or triangular. In the embodiment, the shapes of the tongue 142 and the concave 144 each are semicircular. In addition, the sizes of the tongue 142 and the concave 144 are the same as each other.

A folding line 146 exists between the tongue 142 and the sidewall 14. The tongue 142 can be bended inwardly (i.e., downwardly of FIG. 1) along the folding line 146 so that an angle is formed between the tongue 142 and the sidewall 14. In the embodiment, the angle between the tongue 142 and the sidewall 14 is a right angle. The tongue 142 of each sidewall 14 is adjacent to a concave 144 of an adjacent sidewall 14. The shape and size of the tongue 142 are corresponding to the shape and size the concave 144. In addition, the thickness of the tongue 142 is corresponding to the depth of the concave 144 so as to level the outer surface of the housing structure 10 when sidewalls 14 are bent inwardly along the folding lines 122 and the tongues 142 are bent inwardly along the folding lines 146 to cause the tongues 142 to fittingly engage in the corresponding concaves 144 by which the sidewalls 14 are securely connected together to form the housing structure 10 with the base board 12.

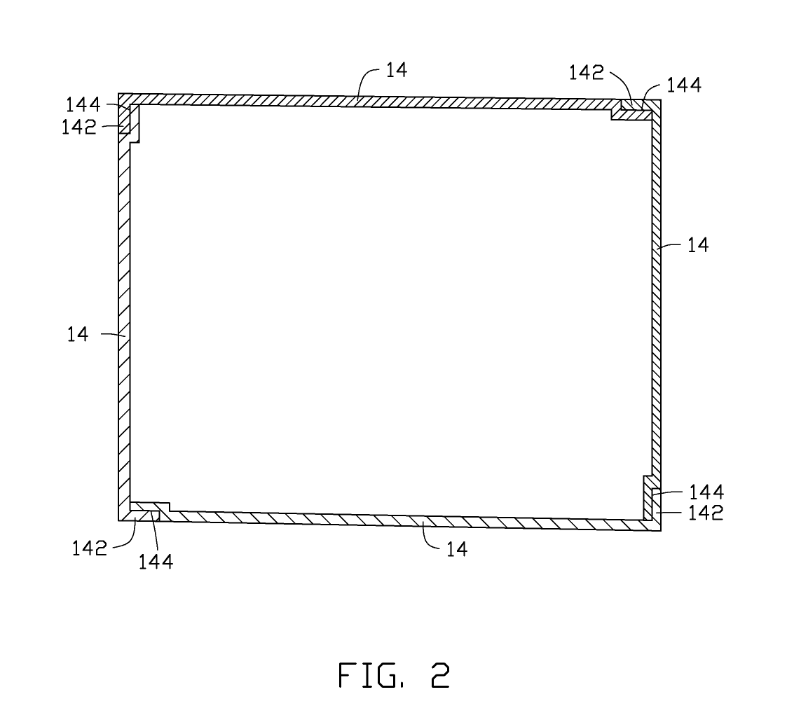

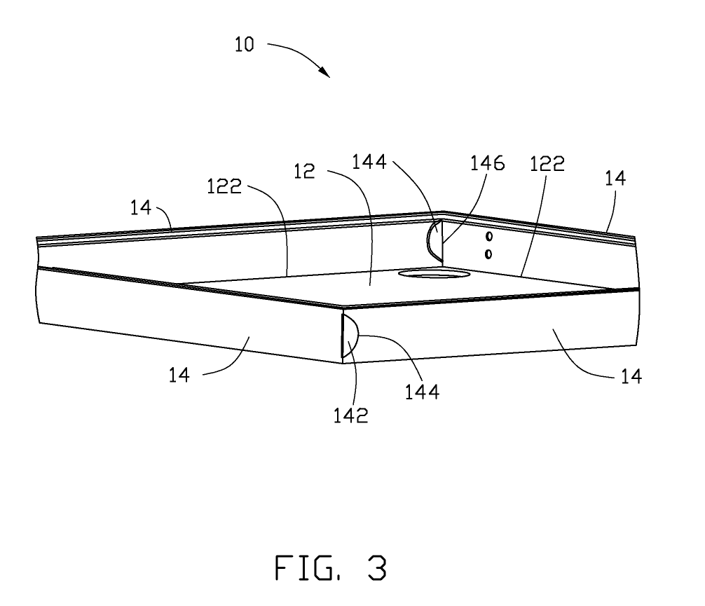

Referring to FIG. 2, in the embodiment, the four sidewalls 14 are connected together to form a rectangular frame around the base board 12 after the sidewalls 14 and the tongues 142 are bended. Also referring to FIG. 3, each sidewall 14 has the tongue 142 of an adjacent sidewall 14 engaging with an outer face thereof, whereby a deviation of the sidewall 14 from its intended position due a rebound after the bending operation is prevented. To reinforce the connectivity between the sidewalls 14, a spot welding is applied to each of the tongues 142 after the bending operation.

Furthermore, the shape of the base board is not limited to square, whereas it may be triangular, circular or other shape. The amount of the sidewall is not limited to four. The amount is adjustable according to the shape of the base board.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A housing structure of a lamp, comprising:
a base board; and
a plurality of sidewalls extending upwardly from a periphery of the base board, one side of each sidewall having at least a tongue, another side thereof having at least a concave, the at least a tongue of one sidewall engaging in the at least a concave of an adjacent sidewall, an outer face of the at least a tongue of the one sidewall being level with an outer surface of the adjacent sidewall defining the at least a concave.

2. The housing structure of claim 1, wherein a first folding line is existed between the base board and each of the sidewalls.

3. The housing structure of claim 2, wherein the at least a tongue is extended outward from the one side of each sidewall, and a second broken line is existed between the at least a tongue and the each sidewall.

4. The housing structure of claim 1, wherein a right angle is existed between the base board and each of the sidewalls.

5. The housing structure of claim 1, wherein a right angle is existed between the each sidewall and the at least a tongue.

6. The housing structure of claim 1, wherein the at least a concave is recessed from an outer surface of the each sidewall to an inner surface of the each sidewall.

7. The housing structure of claim 1, wherein a shape of the at least a tongue is corresponding to a shape of the at least a concave.

8. The housing structure of claim 1, wherein a thickness of the at least a tongue is corresponding to a depth of the at least a concave.

9. The housing structure of claim 1, wherein the at least a tongue is rectangular, triangular, or semicircular.

10. The housing structure of claim 1, wherein the at least a concave is rectangular, triangular, or semicircular.

11. The housing structure of claim 1, wherein a spot welding is applied to the at least a tongue to reinforce the connection between the at least a tongue and the adjacent sidewall.
